(19) United States
(12) Patent Application Publication
(10) Pub. No.: US 2026/0249467 A1
(43) Pub. Date: Aug. 27, 2026

(54) CHARGING ROBOT EQUIPPED WITH SAFETY CONTROLLER AND ELECTRIC VEHICLE CHARGING SYSTEM INCLUDING THE SAME

(71) Applicants: HYUNDAI MOTOR COMPANY, SEOUL (KR); KIA CORPORATION, SEOUL (KR)

(72) Inventors: Hwa Woong Yoo, Hwaseong-si (KR); Ki Hoon Nam, Hwaseong-si (KR); Ji Su Kim, Hwaseong-si (KR); Byung Ho Yoon, Hwaseong-si (KR); Jae Pin Kim, Hwaseong-si (KR)

(73) Assignees: HYUNDAI MOTOR COMPANY, SEOUL (KR); KIA CORPORATION, SEOUL (KR)

(21) Appl. No.: 19/321,835

(22) Filed: Sep. 8, 2025

(30) Foreign Application Priority Data
Feb. 26, 2025 (KR) 10-2025-0025076

(51) Int. Cl. B25J 9/16; B60L 53/16; B60L 53/31; B60L 53/37; B60L 53/60

(52) U.S. Cl. CPC B25J 9/1676; B60L 53/16; B60L 53/31; B60L 53/37; B60L 53/60; G05B 2219/39001

(57) ABSTRACT

A charging robot may include a robot body, an articulated robot arm connected to the robot body and configured to be rotatable about a reference axis, and a safety controller configured to determine a risk degree related to an operation of the robot arm based on a distance between the reference axis of the robot body and an external object and control the operation of the robot arm based on the risk degree, in which the safety controller is configured to score the risk degree as a first risk score within a range from 0 to a first reference value in accordance with the distance between the reference axis and the external object and control the operation of the robot arm based on the first risk score.

### CROSS-REFERENCE TO RELATED APPLICATION

This application claims priority to and the benefit of Korean Patent Application No. 10-2025-0025076 filed in the Korean Intellectual Property Office on Feb. 26, 2025, the entire contents of which are incorporated herein by reference.

### TECHNICAL FIELD

The present disclosure relates to a charging robot equipped with a safety controller and an electric vehicle charging system including the same.

### BACKGROUND

Recently, electric vehicles have been in the limelight as alternatives for reducing environmental pollution and ensuring sustainable energy consumption, and as a result, the proliferation of electric vehicles is rapidly increasing. With the proliferation of electric vehicles, various charging technologies and charging devices are being developed.

In the case of electric vehicle charging devices in the related art, most processes of connecting or disconnecting charging connectors are performed manually, which causes inconveniences to users. In order to solve the above-mentioned problems, an automatic charging system has been proposed which may charge an electric vehicle in an unmanned manner by using a charging robot equipped with an articulated robot arm.

However, an accident may occur when the charging robot operates without recognizing a person or other objects approaching a periphery of the charging robot in case that the charging robot operates to charge the electric vehicle. Therefore, there is a need for safety measures to control the operation of the charging robot.

### SUMMARY

The present disclosure has been made in an effort to provide a charging robot capable of ensuring stability and efficiency by quantifying a risk degree, which is related to an operation of a charging robot, as a risk score and controlling the operation of the charging robot based on the risk score, and an electric vehicle charging system including the same.

A charging robot according to an embodiment of the present disclosure may include a robot body, an articulated robot arm connected to the robot body and configured to be rotatable about a reference axis, and a safety controller configured to determine a risk degree related to an operation of the robot arm based on a distance between the reference axis of the robot body and an external object and control the operation of the robot arm based on the risk degree, in which the safety controller is configured to score the risk degree as a first risk score within a range from 0 to a first reference value in accordance with the distance between the reference axis and the external object and control the operation of the robot arm based on the first risk score.

In an embodiment, the safety controller may divide a peripheral area of the reference axis into a danger area, a caution area, and a safety area, the safety controller may determine the first risk score as the first reference value when the external object is positioned in the danger area, the safety controller may determine the first risk score as 0 when the external object is positioned in the safety area, and the safety controller may calculate the first risk score as a value larger than 0 and smaller than the first reference value by means of functions when the external object is positioned in the caution area.

In an embodiment, the danger area may be defined as an area having a first radius based on the reference axis, the caution area may be defined as an area excluding the danger area from an area having a second radius larger than the first radius based on the reference axis, and the safety area may be defined as an outer area of the caution area.

In an embodiment, the functions may include a reference function defined as Equation 1 below, a downward adjustment function configured to calculate the first risk score by lowering the first risk score in comparison with the reference function; and an upward adjustment function configured to calculate the first risk score by raising the first risk score in comparison with the reference function, and the safety controller may determine the function for calculating the first risk score as any one of the reference function, the downward adjustment function, and the upward adjustment function based on at least one of the types and number of external detection devices configured to detect a position or distance of the external object.

$$y = ax + b \qquad Equation 1$$

$$a = \frac{n}{R 1 - R 2} , b = \frac{nR 2}{R 2 - R 1}$$

where y: first risk score, n: first reference value, R1: first radius, R2: second radius, x: distance between external object and reference axis.

In an embodiment, when the first reference value is defined as 10, the downward adjustment function may include at least one of a first downward adjustment function defined as Equation 2, below and a second downward adjustment function defined as Equation 3 below.

$$y = {log}_{a} x + b \qquad Equation 2$$

$$a = {( \frac{R 1}{R 2} )}^{\frac{1}{10}} , b = - 10 {log}_{\frac{R 1}{R 2}} R 2$$

$$y = \frac{a}{x} + b \qquad Equation 3$$

$$a = \frac{10 R 1 R 2}{R 2 - R 1} , b = \frac{10 R 1}{R 1 - R 2}$$

where y: first risk score, R1: first radius, R2: second radius, x: distance between external object and reference axis.

In an embodiment, when the first reference value is defined as 10, the upward adjustment function may include at least one of a first upward adjustment function defined as Equation 4 below and a second upward adjustment function defined as Equation 5 below.

$$y = 2 ( a x + b ) - ( {log}_{c} x + d ) \qquad Equation 4$$

$$a = \frac{10}{R 1 - R 2} , b = \frac{10 R 2}{R 2 - R 1} , c = {( \frac{R 1}{R 2} )}^{\frac{1}{10}} , d = - 10 {log}_{\frac{R 1}{R 2}} R 2$$

$$y = 2 ( a x + b ) - ( \frac{c}{x} + d ) \qquad Equation 5$$

$$a = \frac{10}{R 1 - R 2} , b = \frac{10 R 2}{R 2 - R 1} , c = \frac{10 R 1 R 2}{R 2 - R 1} , d = \frac{10 R 1}{R 1 - R 2}$$

where y: first risk score, R1: first radius, R2: second radius, x: distance between external object and reference axis.

In an embodiment, the safety controller may determine that the external object is positioned in the danger area when the distance between the external object and the reference axis is equal to or smaller than the first radius, the safety controller may determine that the external object is positioned in the safety area when the distance between the external object and the reference axis is equal to or larger than the second radius, and the safety controller may determine that the external object is positioned in the caution area when the distance between the external object and the reference axis is larger than the first radius and smaller than the second radius.

In an embodiment, the safety controller may maintain the operation of the robot arm when the first risk score is 0, the safety controller may stop the operation of the robot arm when the first risk score is the first reference value, and the safety controller may restrict at least one of a velocity, an acceleration, and an operating range of the robot arm based on the first risk score when the first risk score is larger than 0 and smaller than the first reference value.

In an embodiment, the robot arm may be configured to grip a charger configured to be used to charge an electric vehicle, the safety controller may be configured to receive charger state information from the charger, calculate a second risk score related to the risk degree based on the charger state information, and control the operation of the robot arm based on a value made by adding up the first risk score and the second risk score, and the second risk score may be determined as one of 0 and a second reference value smaller than the first reference value.

In an embodiment, the safety controller may be configured to receive electric vehicle state information from the electric vehicle, calculate a third risk score related to the risk degree based on the electric vehicle state information, and control the operation of the robot arm based on a value made by adding up the first risk score and the third risk score, and the third risk score may be determined as one of 0 and a third reference value smaller than the first reference value.

In an embodiment, the safety controller may maintain the operation of the robot arm when a total risk score made by adding up the first to third risk scores is 0, the safety controller may stop the operation of the robot arm when the total risk score is equal to or larger than the first reference value, and the safety controller may restrict at least one of a velocity, an acceleration, and an operating range of the robot arm based on the total risk score when the total risk score is larger than 0 and smaller than the first reference value.

In an embodiment, the safety controller may determine the second risk score as the second reference value when the charger is in a charged state, the safety controller may determine the second risk score as 0 when the charger is in a non-charged state, the safety controller may determine the third risk score as the third reference value when a gear shift position of the electric vehicle is a D-shift position or an N-shift position, and the safety controller may determine the third risk score as 0 when the gear shift position of the electric vehicle is a P-shift position.

In an embodiment, the first reference value may be a natural number, and the second reference value and the third reference value may be set to 0.5 times the first reference value.

In an embodiment, the external detection device may include at least one of a proximity sensor configured to detect whether the external object is positioned in the danger area and a position detection sensor configured to detect a distance at which the external object is spaced apart from the reference axis.

In an embodiment, the safety controller may calculate the first risk score by means of the upward adjustment function when the external detection device has only one position detection sensor, and the safety controller may calculate the first risk score by means of the downward adjustment function when the external detection device has the proximity sensor and two or more position detection sensors.

An electric vehicle charging system according to an embodiment of the present disclosure may include a charger configured to be coupled to a charging port of an electric vehicle to charge the electric vehicle, a charging robot configured to grip the charger, and a detection device configured to detect an external object that approaches a periphery of the charging robot, in which the charging robot includes a robot body, an articulated robot arm connected to the robot body and configured to be rotatable about a reference axis, and a safety controller configured to determine a risk degree related to an operation of the robot arm based on a distance between the reference axis of the robot body and the external object and control the operation of the robot arm based on the risk degree, in which the safety controller is configured to score the risk degree as a first risk score within a range from 0 to a first reference value in accordance with the distance between the reference axis and the external object and control the operation of the robot arm based on the first risk score.

In an embodiment, the safety controller may divide a peripheral area of the reference axis into a danger area, a caution area, and a safety area, the danger area may be defined as an area having a first radius based on the reference axis, the caution area may be defined as an area excluding the danger area from an area having a second radius larger than the first radius based on the reference axis, the safety area may be defined as an outer area of the caution area, the safety controller may determine the first risk score as the first reference value when the external object is positioned in the danger area, the safety controller may determine the first risk score as 0 when the external object is positioned in the safety area, and the safety controller may calculate the first risk score as a value larger than 0 and smaller than the first reference value by means of functions when the external object is positioned in the caution area.

In an embodiment, the functions may include a reference function defined as Equation 1 below, a downward adjustment function configured to calculate the first risk score by lowering the first risk score in comparison with the reference function; and an upward adjustment function configured to calculate the first risk score by raising the first risk score in comparison with the reference function, and the safety controller may determine the function for calculating the first risk score as any one of the reference function, the downward adjustment function, and the upward adjustment function based on at least one of the types and number of sensors provided in the detection device.

$$y = a x + b \qquad Equation 1$$

$$a = \frac{n}{R 1 - R 2} , b = \frac{nR 2}{R 2 - R 1}$$

(y: first risk score, n: first reference value, R1: first radius, R2: second radius, x: distance between external object and reference axis).

In an embodiment, the detection device may include at least one of a proximity sensor configured to detect whether the external object is positioned in the danger area and a position detection sensor configured to detect a distance at which the external object is spaced apart from the reference axis, the safety controller may calculate the first risk score by means of the upward adjustment function when the detection device has only one position detection sensor, and the safety controller may calculate the first risk score by means of the downward adjustment function when the detection device has the proximity sensor and two or more position detection sensors.

In an embodiment, the safety controller may maintain the operation of the robot arm when the first risk score is 0, the safety controller may stop the operation of the robot arm when the first risk score is the first reference value, and the safety controller may restrict at least one of a velocity, an acceleration, and an operating range of the robot arm based on the first risk score when the first risk score is larger than 0 and smaller than the first reference value.

According to an embodiment of the present disclosure, it is possible to ensure the stability and efficiency by quantifying the risk degree, which is related to the operation of the charging robot, as the risk score and controlling the operation of the charging robot based on the risk score.

In addition, according to an embodiment of the present disclosure, it is possible to efficiently manage the charging robot by selecting different functions for calculating the risk score in accordance with the states of the detection device provided in the charging system.

### BRIEF DESCRIPTION OF THE DRAWINGS

FIG. 1 is a block diagram of an electric vehicle charging system according to an embodiment of the present disclosure.

FIG. 2 is a view illustrating a charging robot of the electric vehicle charging system according to the embodiment of the present disclosure.

FIG. 3 is a view illustrating a danger area and a caution area based on the charging robot according to the embodiment of the present disclosure.

FIG. 4 is a view illustrating an operation of controlling a robot arm in the electric vehicle charging system according to the embodiment of the present disclosure.

FIG. 5 is a graph illustrating a reference function and a downward adjustment function for calculating a first risk score in the electric vehicle charging system according to the embodiment of the present disclosure.

FIG. 6 is a graph illustrating the reference function and an upward adjustment function for calculating the first risk score in the electric vehicle charging system according to the embodiment of the present disclosure.

### DETAILED DESCRIPTION

Hereinafter, some embodiments of the present disclosure will be described in detail with reference to the illustrative drawings. In giving reference numerals to constituent elements of the respective drawings, it should be noted that the same constituent elements will be designated by the same reference numerals, if possible, even though the constituent elements are illustrated in different drawings. Further, in the following description of the embodiments of the present disclosure, a detailed description of related publicly-known configurations or functions will be omitted when it is determined that the detailed description obscures the understanding of the embodiments of the present disclosure.

In addition, the terms including ordinal numbers such as “first” and “second” used in the present specification may be used to describe various constituent elements, but the constituent elements should not be limited by the terms, and these terms are used only to distinguish one constituent element from another constituent element. For example, a first component may be named a second component, and similarly, the second component may also be named the first component, without departing from the scope of the present disclosure. The term “and/or” includes any and all combinations of a plurality of the related and listed items.

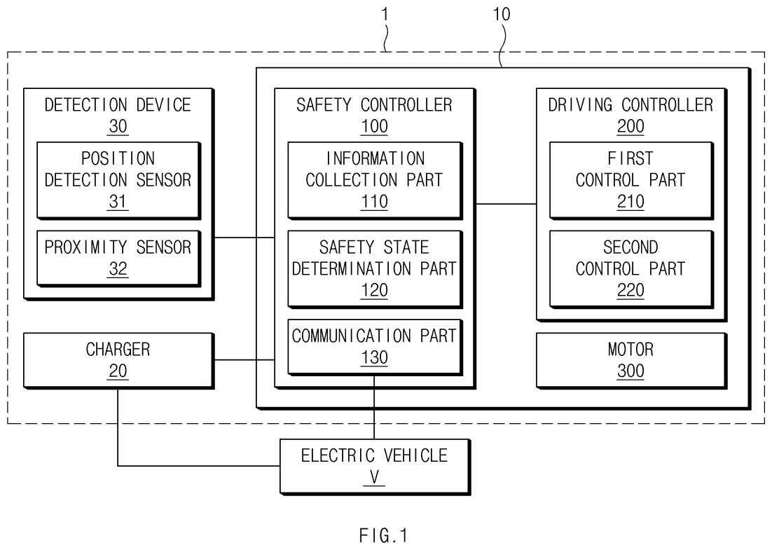

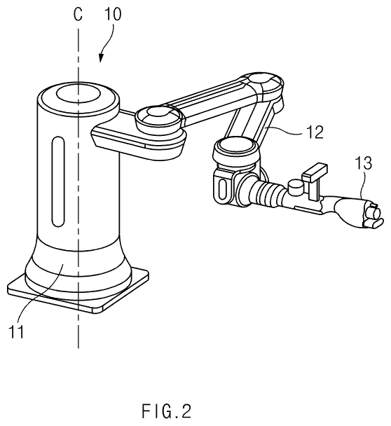

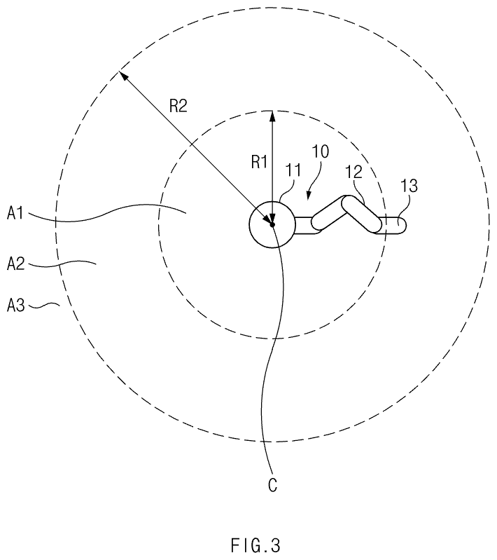

FIG. 1 is a block diagram of an electric vehicle charging system according to an embodiment of the present disclosure. FIG. 2 is a view illustrating a charging robot of the electric vehicle charging system according to the embodiment of the present disclosure. FIG. 3 is a view illustrating a danger area and a caution area based on the charging robot according to the embodiment of the present disclosure.

With reference to FIGS. 1 and 2, an electric vehicle charging system 1 according to the embodiment of the present disclosure may be an automatic charging system capable of charging the electric vehicle V by means of a charging robot 10 configured to grip a charger 20.

The electric vehicle charging system 1 may include the charging robot 10, the charger 20 configured to be connected to a charging port provided in the electric vehicle V to charge the electric vehicle V, and a detection device 30 configured to detect an external object that approaches a periphery of the charging robot 10.

The charging robot 10 may charge the electric vehicle V by gripping the charger 20 and connecting the charger 20 to the charging port of the electric vehicle V.

The charging robot 10 may include a robot body 11, an articulated robot arm 12 connected to the robot body 11 and configured to be rotatable about a reference axis C, and a charger holder 13 provided at an end of the robot arm 12 and configured to grip the charger 20. The robot arm 12 may include a plurality of links rotatably connected to one another, and the charger holder 13 may be provided on a link disposed to be farthest from the robot body 11 among the plurality of links.

Meanwhile, according to the illustrated embodiment, the charging robot 10 is structured such that the robot arm 12 grips the charger 20 separately provided. However, according to various embodiments, the charging robot 10 may have a structure in which the charger holder 13 is provided as a charging port, and the charger 20 is integrated with the robot arm 12.

The charging robot 10 may further include a safety controller 100, a driving controller 200, and a motor 300. For example, at least one of the safety controller 100 and the driving controller 200 may be disposed in the robot body 11. However, the present disclosure is not limited thereto. For example, the motor 300 may be disposed on the robot arm 12 and configured to provide driving power for rotating the plurality of links relative to one another.

The charging robot 10 according to the embodiment of the present disclosure may score a risk degree from an external risk factor and control an operation of the robot arm 12 based on the risk degree. For example, the charging robot 10 may be configured to score a risk degree based on at least one of environment information on the surroundings of the charging robot 10 transferred from the detection device 30, charger state information transferred from the charger 20, and electric vehicle state information transferred from the electric vehicle V, and the charging robot 10 may be configured to control the operation of the robot arm 12 based on a calculated risk score. A process of controlling the operation of the robot arm 12 based on the risk score will be described below in detail with reference to FIG. 3.

The charger 20 may be a device configured to be coupled to a charging terminal provided in the electric vehicle and charge a battery of the electric vehicle V. For example, the charging robot 10 may grip a charging connector or charging plug of the charger 20 and couple the charging connector or charging plug to the charging terminal. Because the charger 20 is a publicly-known component in the technical field, a detailed description thereof will be omitted.

The detection device 30 may be configured to detect an approach of an external object to a peripheral area of the charging robot 10 and recognize a position of the external object. The detection device 30 may transfer the detected information to the safety controller 100 of the charging robot 10. The detection device 30 may include at least one of a proximity sensor 32 and a position detection sensor 31. In addition, the detection device 30 may include one or more position detection sensors 31.

The proximity sensor 32 may detect whether an external object approaches a location within a predetermined radius from the robot body 11. The position detection sensor 31 may detect a distance at which the external object is spaced apart from the robot body 11. For example, the proximity sensor 32 may include a laser sensor, and the position detection sensor 31 may include at least one of a lidar sensor and a camera.

Hereinafter, a process of controlling the operation of the robot arm 12 based on the risk score and components for performing the process will be described with reference to FIGS. 1 to 3.

The charging robot 10 may include the safety controller 100 configured to determine a risk degree related to the operation of the robot arm 12 based on information transferred from at least one of the detection device 30, the charger 20, and the electric vehicle V and determine a control parameter of the robot arm 12 based on the risk degree, and the driving controller 200 configured to control the operation of the robot arm 12 based on the control parameter determined by the safety controller 100.

The safety controller 100 may include an information collection part 110 configured to collect information for determining the risk degree, a safety state determination part 120 configured to score a risk degree as a risk score based on the information collected by the information collection part 110 and determine a control parameter of the robot arm 12 based on the risk score, and a communication part 130 configured to communicate with the detection device 30, the charger 20, and the electric vehicle V. The safety controller 100 may supply electric power to the driving controller 200 or cut off a supply of electric power. For example, the safety controller 100 may cut off the supply of electric power to the driving controller 200 in case that the operation of the robot arm 12 needs to be stopped.

The driving controller 200 may include a first control part 210 configured to generate a motion instruction for the robot arm 12 based on the control parameter set by the safety controller 100 and transmit the motion instruction, and a second control part 220 configured to control the motor 300 provided on the plurality of links based on the motion instruction transmitted from the first control part 210. For example, the second control part 220 may be a motor driver, and the first control part 210 may be a controller configured to control the motor driver. The safety controller 100 may supply electric power to the second control part 220 or cut off the supply of electric power.

The safety controller 100 may be configured to score the risk degree as a first risk score within a range from 0 to a first reference value in accordance with a distance between the reference axis C and the external object and control the operation of the robot arm 12 based on the first risk score. In this case, the first reference value is a natural number.

Specifically, the peripheral area of the robot arm 12 may be divided into a danger area A1, a caution area A2, and a safety area A3. The safety state determination part 120 may determine the first risk score as the first reference value in case that the external object is positioned in the danger area A1, determine the first risk score as 0 in case that the external object is positioned in the safety area A3, and calculate the first risk score as a value larger than 0 and smaller than the first reference value by using a function in case that the external object is positioned in the caution area A2.

In this case, the danger area A1 may be defined as an area having a first radius R1 based on the reference axis C, the caution area A2 may be determined as an area excluding the danger area A1 from an area having a second radius R2 larger than the first radius R1 based on the reference axis C, and the safety area A3 may be defined as an outer area of the caution area A2. That is, the safety area A3 refers to an area disposed outside the second radius R2 based on the reference axis C.

The safety controller 100 may determine functions for calculating the first risk score related to the case in which the external object is positioned in the caution area A2 based on at least one of the types and number of sensors included in the detection device 30. For example, the functions may include a reference function, a downward adjustment function for calculating the first risk score by lowering the first risk score in comparison with the reference function, and an upward adjustment function for calculating the first risk score by raising the first risk score in comparison with the reference function.

Specifically, when the external object is positioned in the caution area A2, the safety state determination part 120 determines whether to calculate the first risk score by using any one of the reference function, the downward adjustment function, and the upward adjustment function based on the types or number of sensors included in the detection device 30. In this case, the reference function may be defined as Equation 1 below:

$$y = a x + b \qquad Equation 1$$

$$a = \frac{n}{R 1 - R 2} , b = \frac{nR 2}{R 2 - R 1}$$

In Equation 1, y represents the first risk score, n represents the first reference value, R1 represents the first radius, R2 represents the second radius, and x represents the distance between the external object and the reference axis C.

For example, the safety state determination part 120 may calculate the first risk score by using the reference function in case that the detection device 30 has the proximity sensor 32 and one position detection sensor 31 or in case that the detection device 30 has two position detection sensors 31 without having the proximity sensor 32.

In addition, the safety state determination part 120 may calculate the first risk score by using the downward adjustment function to lower the first risk score in consideration of the fact that a risk degree evaluation criterion may be lowered because accuracy related to the position information of the external object increases in case that the detection device 30 has the proximity sensor 32 and two position detection sensors 31.

In addition, the safety state determination part 120 may calculate the first risk score by using the upward adjustment function to raise the first risk score in consideration of the fact that the risk degree evaluation criterion needs to be raised because the accuracy related to the position information of the external object decreases in case that the detection device 30 has one position detection sensor 31 without having the proximity sensor 32.

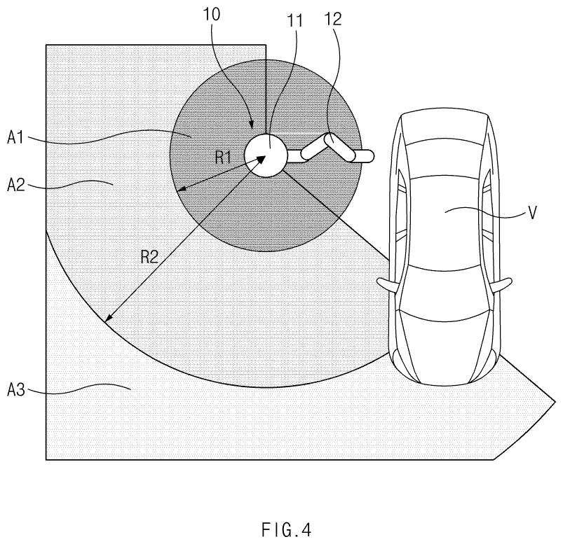

For example, the reference function is a linear function that connects (R1, n) and (R2, 0) in a two-dimensional coordinate system in which a y-axis indicates the first risk score, and an x-axis indicates the distance between the external object and the reference axis C. The downward adjustment function is a function that converts the first risk score related to the distance into a logarithmic function and/or a fractional function so that the downward adjustment function is adjusted to have a y value smaller than the reference function (straight line) with an x value larger than R1 and smaller than R2. The upward adjustment function is a function that symmetrically converts the logarithmic function and/or the fractional function of the downward adjustment function so that the upward adjustment function is adjusted to have a y value larger than the reference function (straight line) with an x value larger than R1 and smaller than R2. The comparison between the reference function, the downward adjustment function, and the upward adjustment function will be described below in detail with reference to FIGS. 4 to 6.

The safety state determination part 120 may determine that the external object is positioned in the danger area A1 in case that the distance between the external object and the reference axis C is equal to or smaller than the first radius R1 (x≤R1). The safety state determination part 120 may determine that the external object is positioned in the safety area A3 in case that the distance between the external object and the reference axis C is equal to or larger than the second radius R2 (x≥R2). The safety state determination part 120 may determine that the external object is positioned in the caution area A2 in case that the distance between the external object and the reference axis Cis larger than the first radius R1 and smaller than the second radius R2 (R1<x<R2).

The safety controller 100 may maintain the operation of the robot arm 12 in case that the first risk score is 0 (y=0). The safety controller 100 may stop the operation of the robot arm 12 in case that the first risk score is the first reference value (y=n). The safety controller 100 may restrict at least one of a velocity, an acceleration, and an operating range of the robot arm 12 based on the first risk score in case that the first risk score is larger than 0 and smaller than the first reference value (0<y<n). Specifically, the safety state determination part 120 may restrict the velocity, the acceleration, and the operating range of the robot arm 12 in response to a magnitude of the calculated first risk score.

The safety controller 100 may determine the risk degree related to the operation of the charging robot 10 by additionally applying state information of the charger 20 and the electric vehicle V in addition to the position information of the external object.

Specifically, the safety controller 100 may control the operation of the robot arm 12 based on a value made by adding up the first risk score and at least one of a second risk score related to a state of the charger 20 and a third risk score related to a state of the electric vehicle V. That is, the safety controller 100 may determine the risk degree related to the operation of the robot arm 12 by additionally considering the states of the charger 20 and the electric vehicle V in addition to whether the external object approaches the periphery of the charging robot 10.

Hereinafter, an embodiment will be described in which the value made by adding both the second risk score and the third risk score to the first risk score is defined as a total risk score, and the operation of the robot arm 12 is controlled based on the total risk score. However, this is provided for illustrative purposes only. The safety controller 100 may control the operation of the robot arm 12 based on a value made by adding only any one of the second risk score and the third risk score to the first risk score.

The safety state determination part 120 may calculate the second risk score related to the risk degree based on charger state information provided from the charger 20. The second risk score may be determined as 0 or a second reference value. In this case, the second reference value is a value smaller than the first reference value. For example, the safety state determination part 120 may determine the second risk score as the second reference value in case that the charger 20 is charging the electric vehicle V. The safety state determination part 120 may determine the second risk score as 0 in case that the charger 20 does not charge the electric vehicle V.

In addition, the safety state determination part 120 may calculate the third risk score related to the risk degree based on electric vehicle state information provided from the electric vehicle V. The third risk score may be determined as 0 or a third reference value. In this case, the third reference value is a value smaller than the first reference value. For example, the safety state determination part 120 may determine the third risk score as the third reference value in case that a gear shift position of the electric vehicle V is a D-shift position or an N-shift position. The safety state determination part 120 may determine the third risk score as 0 in case that the gear shift position of the electric vehicle Vis a P-shift position.

The safety state determination part 120 may maintain the operation of the robot arm 12 in case that the total risk score is 0. The safety state determination part 120 may stop the operation of the robot arm 12 in case that the total risk score is equal to or larger than the first reference value. The safety state determination part 120 may restrict at least one of the velocity, the acceleration, and the operating range of the robot arm 12 based on the total risk score in case that the total risk score is larger than 0 and smaller than the first reference value.

For example, the second reference value of the second risk score and the third reference value of the third risk score may be equal to each other. The second reference value and the third reference value may be 0.5 times the first reference value. For example, the second reference value and the third reference value may be 5 in case that the first reference value is 10. The safety state determination part 120 may stop the operation of the robot arm 12 in case that the total risk score made by adding up the first risk score, the second risk score, and the third risk score is 10. The safety state determination part 120 may normally operate the robot arm 12 in case that the total risk score is 0. The safety state determination part 120 may restrict the operation of the robot arm 12 based on the corresponding score in case that the total risk score is larger than 0 and smaller than 10.

Meanwhile, the above-mentioned numerical values are illustrative and do not limit the embodiment of the present disclosure. In addition, in the present disclosure, the second reference value and the third reference value are not necessarily equal to each other but may be different from each other.

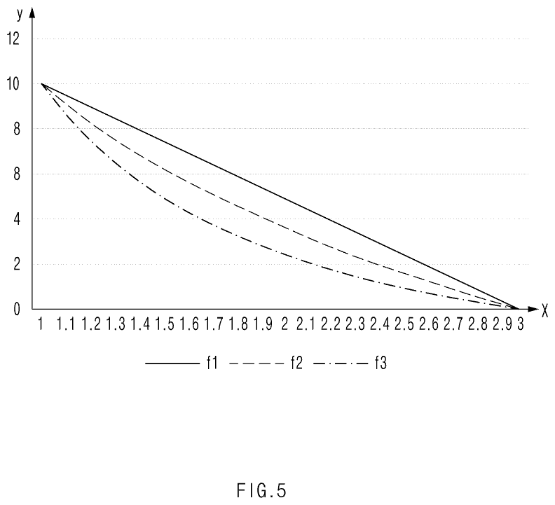

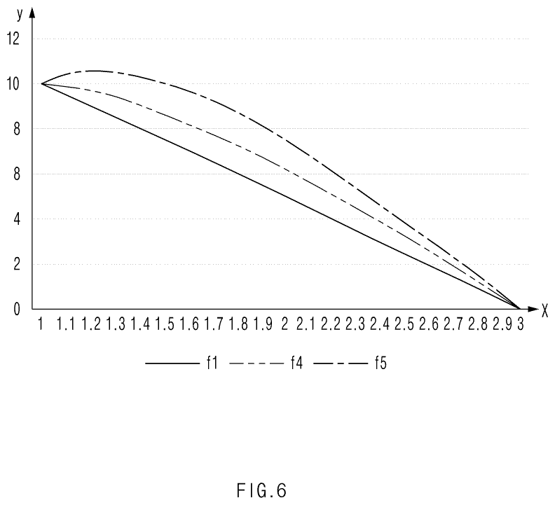

FIG. 4 is a view illustrating an operation of controlling the robot arm in the electric vehicle charging system according to the embodiment of the present disclosure. FIG. 5 is a graph illustrating the reference function and the downward adjustment function for calculating the first risk score in the electric vehicle charging system according to the embodiment of the present disclosure. FIG. 6 is a graph illustrating the reference function and the upward adjustment function for calculating the first risk score in the electric vehicle charging system according to the embodiment of the present disclosure.

Hereinafter, the operation of controlling the robot arm 12 in the electric vehicle charging system 1 according to the present disclosure will be described with reference to FIGS. 4 to 6 and an example in which the first reference value is 10 and the second reference value and the third reference value are 5. Meanwhile, the above-mentioned numerical values are illustrative and do not limit the embodiment of the present disclosure.

The description related to FIGS. 4 to 6 will be described with reference to FIGS. 1 to 3, and a description of the components identical to those described above will be omitted.

First, in case that the first reference value is 10, Equation 1, which defines the reference function, may change to Equation 1-1 below:

$$y = a x + b \qquad Equation l - 1$$

$$a = \frac{10}{R 1 - R 2} , b = \frac{10 R 2}{R 2 - R 1}$$

The downward adjustment function may include a first downward adjustment function made by converting the first risk score y into a logarithmic function with respect to the distance x, and a second downward adjustment function made by converting a first risk score y into the fractional function with respect to the distance x.

In this case, in case that the first reference value is 10, the first downward adjustment function may be defined as Equation 2 below, and the second downward adjustment function may be defined as Equation 3 below:

$$y = {log}_{a} x + b \qquad Equation 2$$

$$a = {( \frac{R 1}{R 2} )}^{\frac{1}{10}} , b = - 10 {log}_{\frac{R 1}{R 2}} R 2$$

$$y = \frac{a}{x} + b \qquad Equation 3$$

$$a = \frac{10 R 1 R 2}{R 2 - R 1} , b = \frac{10 R 1}{R 1 - R 2}$$

In Equation 2 and Equation 3, y represents the first risk score, R1 represents the first radius, R2 represents the second radius, and x represents the distance between the external object and the reference axis C.

The relationships between the reference function, the first downward adjustment function, and the second downward adjustment function may be seen in the graph illustrated in FIG. 5. The graph in FIG. 5 shows that the first radius R1 is 1 m, and the second radius R2 is 3 m.

As illustrated in FIG. 5, a first downward adjustment function f2 and a second downward adjustment function f3 may be calculated by lowering the first risk score in comparison with a reference function f1. In addition, the second downward adjustment function f3 may be calculated by lowering the first risk score in comparison with the first downward adjustment function f2. In case that the safety controller 100 calculates the first risk score by using the downward adjustment function, the safety controller 100 may calculate the first risk score by selecting one of the first downward adjustment function f2 and the second downward adjustment function f3 in accordance with a criterion for determining the risk degree.

The upward adjustment function may include a first upward adjustment function made by symmetrically converting the first downward adjustment function, and a second upward adjustment function made by symmetrically converting the second downward adjustment function.

In this case, in case that the first reference value is 10, the first upward adjustment function may be defined as Equation 4 below, and the second upward adjustment function may be defined as Equation 5 below:

$$y = 2 ( a x + b ) - ( {log}_{c} x + d ) \qquad Equation 4$$

$$a = \frac{10}{R 1 - R 2} , b = \frac{10 R 2}{R 2 - R 1} , c = {( \frac{R 1}{R 2} )}^{\frac{1}{10}} , d = - 10 {log}_{\frac{R 1}{R 2}} R 2$$

$$y = 2 ( a x + b ) - ( \frac{c}{x} + d ) \qquad Equation 5$$

$$a = \frac{10}{R 1 - R 2} , b = \frac{10 R 2}{R 2 - R 1} , c = \frac{10 R 1 R 2}{R 2 - R 1} , d = \frac{10 R 1}{R 1 - R 2}$$

In Equation 4 and Equation 5, y represents the first risk score, R1 represents the first radius, R2 represents the second radius, and x represents the distance between the external object and the reference axis C.

The relationships between the reference function, the first upward adjustment function, and the second upward adjustment function may be seen in the graph illustrated in FIG. 6. The graph in FIG. 6 shows that the first radius R1 is 1 m, and the second radius R2 is 3 m.

As illustrated in FIG. 6, a first upward adjustment function f4 and a second upward adjustment function f5 may be calculated by raising the first risk score in comparison with the reference function f1. In addition, the second upward adjustment function f5 may be calculated by raising the first risk score in comparison with the first upward adjustment function f4. In case that the safety controller 100 calculates the first risk score by using the upward adjustment function, the safety controller 100 may calculate the first risk score by selecting one of the first upward adjustment function f4 and the second upward adjustment function f5 in accordance with a criterion for determining the risk degree.

Hereinafter, various scenarios in which the safety controller 100 controls the operation of the robot arm 12 based on the total risk score made by adding up the first to third risk scores will be described as examples.

For example, in case that the external object is positioned outside the second radius R2 (in the safety area A3), the charger 20 is in a charged state, and the electric vehicle V is placed at the D-shift position, the first risk score is 0, the second risk score is 5, and the third risk score is 5, such that the total risk score is 10, and the safety controller 100 stops the operation of the robot arm 12.

For example, in case that the external object is positioned inside the first radius R1 (in the danger area A1), the charger 20 is in a non-charged state, and the electric vehicle V is placed at the P-shift position, the first risk score is 10, and the second risk score and the third risk score are 0, such that the total risk score is 10, and the safety controller 100 stops the operation of the robot arm 12.

For example, in case that the external object is positioned at a position at which the first risk score is calculated as 3 between the first radius R1 and the second radius R2 (in the caution area A2), the charger 20 is in a charged state, and the electric vehicle Vis placed at the P-shift position, the first risk score is 3, the second risk score is 5, and the third risk score is 0, such that the total risk score is 8, and the safety controller 100 restricts the operation of the robot arm 12 on the basis that the total risk score is 8.

The equation, which indicates that the velocity of the robot arm 12 is restricted based on the total risk score, may be defined as Equation 6 below:

$$V = \frac{1}{2} {A ( \frac{S - b}{a} )}^{2} \qquad Equation 6$$

$$a = \frac{10}{R 1 - R 2} , b = \frac{10 R 2}{R 2 - R 1}$$

In Equation 6, V represents the velocity of the robot arm 12, A represents a stopping acceleration, S represents the total risk score, R1 represents the first radius, and R2 represents the second radius.

In addition, the equation, which indicates that the operating range of the robot arm 12 is restricted based on the total risk score, may be defined as Equation 7 below:

$$\vert θ \vert = - 4 S + 40 \qquad Equation 7$$

In Equation 7, θ represents the operating range of the robot arm 12, and S represents the total risk score.

Meanwhile, Equation 6 and Equation 7 are examples of calculation formulas for restricting the velocity and the operating range of the robot arm 12 based on the total risk score. The present disclosure may be configured to restrict the operation of the robot arm 12 based on the total risk score by utilizing various calculation formulas.

The above description is simply given to illustratively describe the technical spirit of the present disclosure, and those skilled in the art to which the present disclosure pertains will appreciate that various changes and modifications are possible without departing from the essential characteristic of the present disclosure. Therefore, the embodiments disclosed in the present disclosure are provided for illustrative purposes only but are not intended to limit the technical spirit of the present disclosure. The scope of the technical spirit of the present disclosure is not limited thereby. The protective scope of the present disclosure should be construed based on the following claims, and all the technical spirit in the equivalent scope thereto should be construed as falling within the scope of the present disclosure.

What is claimed is:

1. A charging robot comprising:
a robot body;
an articulated robot arm connected to the robot body and configured to be rotatable about a reference axis; and
a safety controller configured to determine a risk degree related to an operation of the articulated robot arm based on a distance between the reference axis of the robot body and an external object, and to control the robot arm based on the risk degree,
wherein the safety controller is configured to score the risk degree as a first risk score within a range from 0 to a first reference value in accordance with the distance between the reference axis and the external object and control the operation of the robot arm based on the first risk score.

2. The charging robot of claim 1, wherein the safety controller divides a peripheral area of the reference axis into a danger area, a caution area, and a safety area;
wherein the safety controller is configured to determine the first risk score as the first reference value when the external object is positioned in the danger area;
wherein the safety controller is configured to determine the first risk score as 0 when the external object is positioned in the safety area; and
wherein the safety controller is configured to calculate the first risk score as a value larger than 0 and smaller than the first reference value by at least one function when the external object is positioned in the caution area.

3. The charging robot of claim 2, wherein the danger area is defined as an area having a first radius based on the reference axis, wherein the caution area is defined as an area excluding the danger area from an area having a second radius larger than the first radius based on the reference axis, and wherein the safety area is defined as an outer area of the caution area.

4. The charging robot of claim 3, wherein the at least one function comprises:
a reference function defined as:
$$y = ax + b$$
$$a = \frac{n}{R 1 - R 2} , b = \frac{nR 2}{R 2 - R 1}$$
where y is the first risk score, n is the first reference value, R1 is the first radius, R2 is the second radius, and x is the distance between the external object and the reference axis;
a downward adjustment function configured to calculate the first risk score by lowering the first risk score in comparison with the reference function; and
an upward adjustment function configured to calculate the first risk score by raising the first risk score in comparison with the reference function;
wherein the safety controller is configured to determine the function for calculating the first risk score as any one of the reference function, the downward adjustment function, and the upward adjustment function based on at least one of the types and number of external detection devices configured to detect a position or distance of the external object.

5. The charging robot of claim 4, wherein when the first reference value is defined as 10, the downward adjustment function comprises at least one of a first downward adjustment function defined as:
$$y = {log}_{a} x + b$$
$$a = {( \frac{R 1}{R 2} )}^{\frac{1}{10}} , b = - 10 {log}_{\frac{R 1}{R 2}} R 2$$
and a second downward adjustment function defined as:
$$y = \frac{a}{x} + b$$
$$a = \frac{10 R 1 R 2}{R 2 - R 1} , b = \frac{10 R 1}{R 1 - R 2}$$
where y is the first risk score, R1 is the first radius, R2 is the second radius, and x is the distance between the external object and the reference axis.

6. The charging robot of claim 4, wherein when the first reference value is defined as 10, the upward adjustment function comprises at least one of a first upward adjustment function defined as:
$$y = 2 ( a x + b ) - ( {log}_{c} x + d )$$
$$a = \frac{10}{R 1 - R 2} , b = \frac{10 R 2}{R 2 - R 1} , c = {( \frac{R 1}{R 2} )}^{\frac{1}{10}} , d = - 10 {log}_{\frac{R 1}{R 2}} R 2 ,$$
and a second upward adjustment function defined as:
$$y = 2 ( a x + b ) - ( \frac{c}{x} + d )$$
$$a = \frac{10}{R 1 - R 2} , b = \frac{10 R 2}{R 2 - R 1} , c = \frac{10 R 1 R 2}{R 2 - R 1} , d = \frac{10 R 1}{R 1 - R 2} ,$$
where y is the first risk score, R1 is the first radius, R2 is the second radius, and x is the distance between the external object and the reference axis.

7. The charging robot of claim 3, wherein the safety controller is configured to determine that the external object is positioned in the danger area when the distance between the external object and the reference axis is equal to or smaller than the first radius;
wherein the safety controller is configured to determine that the external object is positioned in the safety area when the distance between the external object and the reference axis is equal to or larger than the second radius; and
wherein the safety controller is configured to determine that the external object is positioned in the caution area when the distance between the external object and the reference axis is larger than the first radius and smaller than the second radius.

8. The charging robot of claim 2, wherein the safety controller is configured to maintain the operation of the robot arm when the first risk score is 0;
wherein the safety controller is configured to stop the operation of the robot arm when the first risk score is the first reference value; and
wherein the safety controller is configured to restrict at least one of a velocity, an acceleration, and an operating range of the robot arm based on the first risk score when the first risk score is larger than 0 and smaller than the first reference value.

9. The charging robot of claim 2, wherein the robot arm is configured to grip a charger configured to charge an electric vehicle;
wherein the safety controller is configured to receive charger state information from the charger, to calculate a second risk score related to the risk degree based on the charger state information, and to control the operation of the robot arm based on a value made by adding up the first risk score and the second risk score; and
wherein the second risk score is determined as one of 0 and a second reference value smaller than the first reference value.

10. The charging robot of claim 9, wherein the safety controller is configured to receive electric vehicle state information from the electric vehicle, to calculate a third risk score related to the risk degree based on the electric vehicle state information, and to control the operation of the robot arm based on a value made by adding up the first risk score and the third risk score; and
wherein the third risk score is determined as one of 0 and a third reference value smaller than the first reference value.

11. The charging robot of claim 10, wherein the safety controller is configured to maintain the operation of the robot arm when a total risk score made by adding up the first to third risk scores is 0;
wherein the safety controller is configured to stop the operation of the robot arm when the total risk score is equal to or larger than the first reference value; and
wherein the safety controller is configured to restrict at least one of a velocity, an acceleration, and an operating range of the robot arm based on the total risk score when the total risk score is larger than 0 and smaller than the first reference value.

12. The charging robot of claim 10, wherein the safety controller is configured to determine the second risk score as the second reference value when the charger is in a charged state;
wherein the safety controller is configured to determine the second risk score as 0 when the charger is in a non-charged state;
wherein the safety controller is configured to determine the third risk score as the third reference value when a gear shift position of the electric vehicle is a D-shift position or an N-shift position; and
wherein the safety controller is configured to determine the third risk score as 0 when the gear shift position of the electric vehicle is a P-shift position.

13. The charging robot of claim 10, wherein the first reference value is a natural number; and
wherein the second reference value and the third reference value are set to 0.5 times the first reference value.

14. The charging robot of claim 4, wherein the external detection device comprises at least one of a proximity sensor configured to detect whether the external object is positioned in the danger area, and a position detection sensor configured to detect a distance at which the external object is spaced apart from the reference axis.

15. The charging robot of claim 14, wherein the safety controller is configured to calculate the first risk score by the upward adjustment function when the external detection device has only one position detection sensor; and
wherein the safety controller is configured to calculate the first risk score by the downward adjustment function when the external detection device has the proximity sensor and two or more position detection sensors.

16. An electric vehicle charging system comprising:
a charger coupled to a charging port of an electric vehicle and configured to charge the electric vehicle;
a charging robot configured to grip the charger; and
a detection device configured to detect an external object that approaches a periphery of the charging robot;
wherein the charging robot comprises:
a robot body;
an articulated robot arm connected to the robot body and configured to be rotatable about a reference axis; and
a safety controller configured to determine a risk degree related to an operation of the robot arm based on a distance between the reference axis of the robot body and the external object and control the operation of the robot arm based on the risk degree;
wherein the safety controller is configured to score the risk degree as a first risk score within a range from 0 to a first reference value in accordance with the distance between the reference axis and the external object, and to control the operation of the robot arm based on the first risk score.

17. The electric vehicle charging system of claim 16, wherein the safety controller divides a peripheral area of the reference axis into a danger area, a caution area, and a safety area;
wherein the danger area is defined as an area having a first radius based on the reference axis;
wherein the caution area is defined as an area excluding the danger area from an area having a second radius larger than the first radius based on the reference axis;
wherein the safety area is defined as an outer area of the caution area;
wherein the safety controller is configured to determine the first risk score as the first reference value when the external object is positioned in the danger area;
wherein the safety controller is configured to determine the first risk score as 0 when the external object is positioned in the safety area; and
wherein the safety controller is configured to calculate the first risk score as a value larger than 0 and smaller than the first reference value by at least one function when the external object is positioned in the caution area.

18. The electric vehicle charging system of claim 17, wherein the at least one function comprises:
a reference function defined as:
$$y = a x + b$$
$$a = \frac{n}{R 1 - R 2} , b = \frac{nR 2}{R 2 - R 1} ,$$
where y is the first risk score, n is the first reference value, R1 is the first radius, R2 is the second radius, and x is the distance between the external object and the reference axis;
a downward adjustment function configured to calculate the first risk score by lowering the first risk score in comparison with the reference function; and
an upward adjustment function configured to calculate the first risk score by raising the first risk score in comparison with the reference function; and
wherein the safety controller is configured to determine the function for calculating the first risk score as any one of the reference function, the downward adjustment function, and the upward adjustment function based on at least one of the types and number of sensors provided in the detection device.

19. The electric vehicle charging system of claim 18, wherein the detection device comprises at least one of a proximity sensor configured to detect whether the external object is positioned in the danger area, and a position detection sensor configured to detect a distance at which the external object is spaced apart from the reference axis;
wherein the safety controller is configured to calculate the first risk score by the upward adjustment function when the detection device has only one position detection sensor; and
wherein the safety controller is configured to calculate the first risk score by the downward adjustment function when the detection device has the proximity sensor and two or more position detection sensors.

20. The electric vehicle charging system of claim 16, wherein the safety controller maintains the operation of the robot arm when the first risk score is 0;
wherein the safety controller is configured to stop the operation of the robot arm when the first risk score is the first reference value; and
wherein the safety controller is configured to restrict at least one of a velocity, an acceleration, and an operating range of the robot arm based on the first risk score when the first risk score is larger than 0 and smaller than the first reference value.
